(19) United States
(12) Patent Application Publication
(10) Pub. No.: US 2019/0324640 A1
(43) Pub. Date: Oct. 24, 2019

(54) ELECTRONIC DEVICE FOR PROVIDING USER INTERFACE ACCORDING TO ELECTRONIC DEVICE USAGE ENVIRONMENT AND METHOD THEREFOR

(71) Applicant: Samsung Electronics Co., Ltd., Gyeonggi-do (KR)

(72) Inventors: Jae-Hyung PARK, Gyeonggi-do (KR); Hae-Chang LEE, Gyeonggi-do (KR); Hae-Dong LEE, Daegu (KR)

(21) Appl. No.: 16/476,699

(22) PCT Filed: Jan. 12, 2018
(86) PCT No.: PCT/KR2018/000618

§ 371 Date: Jul. 9, 2019

(30) Foreign Application Priority Data
Jan. 13, 2017 (KR) 10-2017-0006435

(51) Int. Cl. G06F 3/0488

(52) U.S. Cl. CPC G06F 3/04886; G06F 3/044; G06F 2203/04803

(57) ABSTRACT

The present invention provides an electronic device for providing a user interface according to an electronic device usage environment and a method therefor. An electronic device according to various embodiments comprises: a touch screen; a sensor formed on an at least partial area of the touch screen; and a processor, wherein the processor may display a user interface corresponding to a content on the touch screen to allow the user interface to be controlled through the touch screen and, when at least a part of the touch screen is identified, through the touch screen, as being positioned under water, may display the user interface through the at least a partial area of the touch screen to allow the user interface to be controlled through the sensor. In addition, other embodiments are possible.

### TECHNICAL FIELD

Various embodiments of the present disclosure relate to an electronic device and a method for providing a user interface corresponding to a user environment of the electronic device.

### BACKGROUND ART

Recently, a mobile device such as a smartphone has become a daily necessity, and user authentication has become important because the mobile device includes personal data. With the development of performance and recognition technologies of mobile devices, a biometric authentication technology has been applied for user authentication, and fingerprint recognition is the most common one of various biometric recognition technologies. Fingerprint recognition-based authentication is very rare and has superior recognition performance.

A mobile device provides a user interface using a touch sensor. Generally, a touch sensor may be implemented as various types, among which the most commonly used is the capacitive touch sensor which is widely used because of having fast response speed and a possibility to detect multi-touches.

### DETAILED DESCRIPTION OF THE INVENTION

### Technical Problem

Various embodiments of the present disclosure provide an electronic device and a method for providing a user interface by using a sensor other than a capacitive touch sensor when the electronic device is located under water.

### Technical Solution

Various embodiments of the present disclosure may provide an electronic device and a method for providing a user interface corresponding to a user environment of the electronic device.

According to various embodiments of the present disclosure, an electronic device includes a touch screen, a sensor formed in at least a partial area of the touch screen, and a processor, in which the processor is configured to display a user interface corresponding to contents on the touch screen to allow the user interface to be controlled through the touch screen and to display the user interface in the at least a partial area of the touch screen to allow the user interface to be controlled through the sensor, when determining through the touch screen that at least a part of the touch screen is located under water.

According to various embodiments of the present disclosure, in a non-transitory recording medium having stored therein instructions for executing a method for controlling an electronic device, the instructions are configured to cause, when executed by at least one processor, the at least one processor to perform at least one operation which includes displaying a user interface corresponding to contents on the touch screen to allow the user interface to be controlled through the touch screen and displaying the user interface in at least a partial area of the touch screen to allow the user interface to be controlled through a sensor formed in the at least a partial area of the touch screen, when determining through the touch screen that at least a part of the touch screen is located under water.

### Advantageous Effects

According to various embodiments of the present disclosure, when an electronic device is located under water, the electronic device may be controlled using a user interface corresponding to a sensor other than a touch sensor.

### BRIEF DESCRIPTION OF DRAWINGS

FIG. 1 illustrates a network environment including an electronic device according to various embodiments of the present disclosure.

FIG. 2 is a block diagram of an electronic device according to various embodiments of the present disclosure.

FIG. 3 is a block diagram of a programming module according to various embodiments of the present disclosure.

FIGS. 4A and 4B are block diagrams of an electronic device according to various embodiments of the present disclosure.

FIGS. 5A, 5B, and 5C show examples for describing a method of determining whether an electronic device is located under water through a first sensor, according to various embodiments of the present disclosure.

FIG. 6 is a block diagram showing a structure of a touch screen according to various embodiments of the present disclosure.

FIGS. 7A and 7B show examples for describing an active area of a display according to various embodiments of the present disclosure.

FIGS. 8A, 8B, and 8C show examples of a first area of a sensor according to various embodiments of the present disclosure.

FIGS. 9A, 9B, 9C, 9D, 9E, and 9F show examples for describing a method of providing a user interface based on a location of an electronic device, according to various embodiments of the present disclosure.

FIGS. 10A, 10B, 10C, and 10D show examples of a first area according to various embodiments of the present disclosure.

FIGS. 11A and 11B show examples of a first user interface and a second user interface according to various embodiments of the present disclosure.

FIGS. 12A and 12B are flowcharts illustrating a method of providing a user interface based on a location of an electronic device, according to various embodiments of the present disclosure.

FIG. 13 is a flowchart illustrating a method of providing a user interface based on a location of an electronic device according to various embodiments of the present disclosure.

FIG. 14 is a flowchart illustrating a method of providing a user interface based on a location of an electronic device according to various embodiments of the present disclosure.

### MODE FOR CARRYING OUT THE INVENTION

Hereinafter, various embodiments of the present disclosure will be disclosed with reference to the accompanying drawings. However, embodiments and terms used therein are not intended to limit the present disclosure to particular embodiments, and it should be construed as including various modifications, equivalents, and/or alternatives according to the embodiments of the present disclosure. With regard to the description of the drawings, similar reference numerals may be used to refer to similar or related elements. It is to be understood that a singular form of a noun corresponding to an item may include one or more of the things, unless the relevant context clearly indicates otherwise. In the present disclosure, an expression such as “A or B,” “at least one of A or/and B,” or “one or more of A or/and B” may include all possible combinations of together listed items. Expressions such as “first,” “second,” “primarily,” or “secondary,” used herein may represent various elements regardless of order and/or importance and do not limit corresponding elements. When it is described that an element (such as a first element) is “operatively or communicatively coupled with/to” or “connected” to another element (such as a second element), the element can be directly connected to the other element or can be connected to the other element through another element (e.g., a third element).

An expression “configured to (or set)” used in the present disclosure may be replaced with, for example, “suitable for,” “having the capacity to,” “adapted to,” “made to,” “capable of,” or “designed to” according to a situation. Alternatively, in some situation, an expression “apparatus configured to” may mean that the apparatus “can” operate together with another apparatus or component. For example, a phrase “a processor configured (or set) to perform A, B, and C” may be a dedicated processor (e.g., an embedded processor) for performing a corresponding operation or a generic-purpose processor (such as a central processing unit (CPU) or an application processor) that can perform a corresponding operation by executing at least one software program stored at a memory device.

An electronic device according to various embodiments of the present disclosure may include at least one of, for example, a smartphone, a tablet personal computer (PC), a mobile phone, a video phone, an electronic-book (e-book) reader, a desktop PC, a laptop PC, a netbook computer, a workstation, a server, a personal digital assistant (PDA), a portable multimedia player (PMP), an MP3 player, mobile medical equipment, a camera, or a wearable device. Examples of the wearable device may include at least one of an accessory type (e.g., a watch, a ring, a bracelet, an anklet, a necklace, glasses, contact lenses, head-mounted device (HMD), etc.), a fabric or cloth-integrated type (e.g., electronic clothing, etc.), a body-attached type (e.g., a skin pad, a tattoo, etc.), a body implantable circuit, or the like. In some embodiments, the electronic device may include, for example, at least one of a television (TV), a digital video disk (DVD) player, audio equipment, a refrigerator, an air conditioner, a vacuum cleaner, an oven, a microwave oven, a laundry machine, an air cleaner, a set-top box, a home automation control panel, a security control panel, a media box (e.g., Samsung HomeSync™, Apple TV™, or Google TV™), a game console (e.g., Xbox™ or PlayStation™), an electronic dictionary, an electronic key, a camcorder, or an electronic frame.

In other embodiments, the electronic device may include at least one of various medical equipment (for example, magnetic resonance angiography (MRA), magnetic resonance imaging (MRI), computed tomography (CT), an imaging device, or an ultrasonic device), a navigation system, a global positioning system (GPS) receiver, an event data recorder (EDR), a flight data recorder (FDR), a vehicle infotainment device, electronic equipment for ships (e.g., a navigation system and gyro compass for ships), avionics, a security device, a vehicle head unit, an industrial or home robot, an automatic teller's machine (ATM), a point of sales (POS), Internet of things (e.g., electric bulbs, various sensors, electricity or gas meters, sprinkler devices, fire alarm devices, thermostats, streetlights, toasters, exercise machines, hot-water tanks, heaters, boilers, and so forth). According to some embodiments, the electronic device may include a part of furniture, a building/structure or a part of a vehicle, an electronic board, an electronic signature receiving device, a projector, and various measuring instruments (e.g., a water, electricity, gas, electric wave measuring device, etc.). According to various embodiments, the electronic device may be flexible or may be a combination of two or more of the above-described various devices. According to an embodiment of the disclosure, the electronic devices are not limited to those described above. Herein, the term “user” used in various embodiments of the present disclosure may refer to a person who uses the electronic device or a device using the electronic device (e.g., an artificial intelligence electronic device).

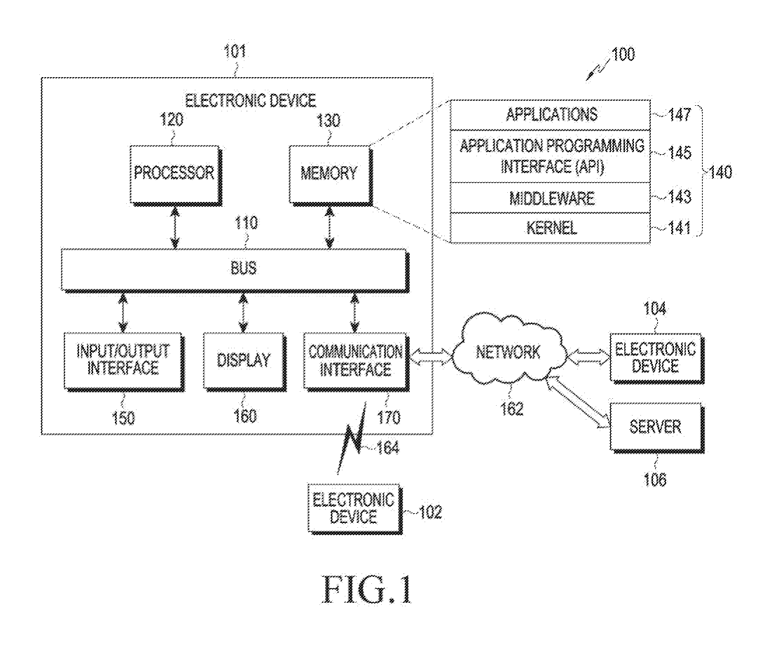

Referring to FIG. 1, an electronic device 101 in a network environment 100 according to various embodiments of the present disclosure is disclosed. The electronic device 101 may include a bus 110, a processor 120, a memory 130, an input/output (I/O) interface 150, a display 160, a communication interface 170, and a sensor module 180. According to some embodiments, the electronic device 101 may omit at least one of the foregoing elements or may further include other elements.

The bus 110 may include a circuit for connecting, e.g., the elements 110 to 180 and delivering communication (e.g., a control message or data) between the elements 110 to 180.

The processor 120 may include one or more of a central processing unit (CPU), an application processor (AP), and a communication processor (CP). The processor 120 may perform operations or data processing for control and/or communication of, for example, at least one other elements of the electronic device 101.

According to an embodiment of the present disclosure, the processor 120 may display a user interface corresponding to contents on a touch screen (e.g., the display 160) to allow the user interface to be controlled through the touch screen, and display the user interface on at least a partial area of the touch screen to allow the user interface to be controlled through a sensor when determining through the touch screen that at least a part of the touch screen is located under water. The contents may include at least one application or at least one of an execution screen, a play screen, a reading screen, a preview screen, or the like related to an application, music, a moving image, a camera, a document, etc. The user interface may include a graphic object including at least one of an execution or shortcut icon, a controller, a scroll, a menu, etc., corresponding to the contents. For example, the user interface may include a graphic object including an execution or shortcut icon corresponding to at least one application or a graphic object including at least one of an icon, a controller, a scroll, a menu, etc., forming a screen (or included in a screen).

According to various embodiments of the present disclosure, the processor 120 may provide a first user interface corresponding to a first sensor (e.g., a capacitive touch sensor) of the sensor module 180, determine whether at least a part of the electronic device 101 (or a touch screen) is located under water, and provide a second user interface corresponding to a second sensor (e.g., a fingerprint sensor or an optical sensor) of the sensor module 180 when determining that the at least a part of the electronic device 101 is located under water. For example, the first user interface may include a graphic object including an execution or shortcut icon corresponding to at least one application or a graphic object including a controller, a scroll, a menu, etc., corresponding to at least one of an execution screen, a play screen, a reading screen, a preview screen, etc., related to an application, music, a moving image, a camera, a document, etc. The second user interface may include a graphic object including an execution or shortcut icon corresponding to a part of at least one application or a graphic object including a controller, a scroll, a menu, etc., corresponding to at least one of an execution screen, a play screen, a reading screen, a preview screen, etc., related to an application, music, a moving image, a camera, a document, etc. The part of the at least one application may be an application that is available under water.

When detecting a fingerprint through the second sensor, the processor 120 may identify an input form or direction of a finger by analyzing a fingerprint image corresponding to the detected fingerprint, and identify the detected fingerprint as a first input such as a touch, a drag, a swipe, a pinch in/out, etc., based on the identified input form or direction. The processor 120 may perform a function corresponding to the identified first input.

The memory 130 may include a volatile and/or nonvolatile memory. The memory 130 may store, for example, instructions or data associated with at least one of the other elements of the electronic device 101.

According to an embodiment of the present disclosure, the memory 130 may store software and/or a program 140. The program 140 may include at least one of, for example, a kernel 141, middleware 143, an application programming interface (API) 145, or an application program (or “application”) 147, and/or a location providing module 149. At least some of the kernel 141, the middleware 143, and the API 145 may be referred to as an operating system (OS).

The kernel 141 may control or manage, for example, system resources (e.g., the bus 110, the processor 120, the memory 130, etc.) used to execute operations or functions implemented in other programs (e.g., the middleware 143, the API 145, or the application program 147). The kernel 141 provides an interface through which the middleware 143, the API 145, or the application program 147 accesses separate components of the electronic device 101 to control or manage the system resources.

The middleware 143 may work as an intermediary for allowing, for example, the API 145 or the application program 147 to exchange data in communication with the kernel 141. In addition, the middleware 143 may process one or more task requests received from the application program 147 based on priorities. For example, the middleware 143 may give a priority for using a system resource (e.g., the bus 110, the processor 120, the memory 130, etc.) of the electronic device 101 to at least one of the application programs 147, and may process the one or more task requests. The API 145 is an interface used for the application 147 to control a function provided by the kernel 141 or the middleware 143, and may include, for example, at least one interface or function (e.g., an instruction) for file control, window control, image processing or character control. The I/O interface 150 may deliver, for example, an instruction or data input from a user or another external device to other component(s) of the electronic device 101, or output an instruction or data received from other component(s) of the electronic device 101 to a user or another external device.

According to an embodiment of the present disclosure, the location providing module 149 may collect location information of the electronic device 101, process the collected location information into location data corresponding to a specific accuracy, and provide the location data. For example, the location providing module 149 may collect the location information, process the collected location information into the location data corresponding to the specific accuracy, and provide at least one application.

The display 160 may include, for example, a liquid crystal display (LCD), a light emitting diode (LED) display, an organic light emitting diode (OLED) display, a microelectromechanical system (MEMS) display, or an electronic paper display. The display 160 may, for example, display various contents (e.g., a text, an image, video, an icon, and/or a symbol, etc.) to users. According to various embodiments of the present disclosure, the display 160 may include a touch screen, and receives a touch, a gesture, proximity, a drag, a swipe, or a hovering input, for example, by using an electronic pen or a part of the body of a user.

The communication interface 170 establishes communication between the electronic device 101 and an external device (e.g., the vehicle device 102, the electronic device 104, or the server 106). For example, the communication interface 170 may be connected to a network 162 through a wireless communication or wired communication to communicate with an external device (e.g., the second external electronic device 104 or the server 106).

Wireless communication may include a cellular communication protocol using at least one of, for example, long-term evolution (LTE), LTE advance (LTE-A), code division multiple access (CDMA), wideband CDMA (WCDMA), universal mobile telecommunications system (UMTS), wireless broadband (WiBro), global system for mobile communications (GSM), and so forth. According to an embodiment, the wireless communication may include at least one of Wireless Fidelity (WiFi), Bluetooth, Bluetooth Low Energy (BLE), Zigbee, near field communication (NFC), magnetic secure transmission (MST), radio frequency (RF), and a body area network (BAN). According to an embodiment, the wireless communication may include a global navigation satellite system (GNSS). The GNSS may include, for example, at least one of a global positioning system (GPS), a global navigation satellite system (Glonass), a Beidou navigation satellite system (“Beidou”), and Galileo, the European global satellite-based navigation system. Hereinbelow, “GPS” may be used interchangeably with “GNSS”. The wired communication may include, for example, at least one of a universal serial bus (USB), a high definition multimedia interface (HDMI), a recommended standard (RS)-232, power line communication, a plain old telephone service (POTS), and so forth. The network 162 may include a telecommunications network, for example, at least one of a computer network (e.g., a local area network (LAN) or a wide area network (WAN)), Internet, and a telephone network.

The sensor module 180 may include the first sensor (e.g., the touch sensor) and the second sensor (e.g., the fingerprint sensor or the optical sensor), and may detect a first input (e.g., a touch, a drag, a swipe, a pinch in/out, etc.) through the first sensor and a second input (e.g., a fingerprint, etc.) through the second sensor.

Each of the first external electronic device 102 and the second external electronic device 104 may be a device of the same type as or a different type than the electronic device 101.

According to various embodiments of the present disclosure, some or all of operations performed by the electronic device 101 may be performed in another electronic device or a plurality of electronic devices (e.g., the electronic device 102 or 104, or the server 106).

According to an embodiment of the present disclosure, when the electronic device 101 has to perform a function or a service automatically or at a request, the electronic device 101 may request another device (e.g., the electronic devices 102 or 104 or the server 106) to perform at least some functions associated with the function or the service instead of or in addition to executing the function or the service. The another electronic device (e.g., the electronic device 102 or 104 or the server 106) may execute the requested function or additional function and deliver the execution result to the electronic device 101. The electronic device 101 may then process or further process the received result to provide the requested function or service. To that end, a cloud computing, distributed computing, or client-server computing technology may be used, for example.

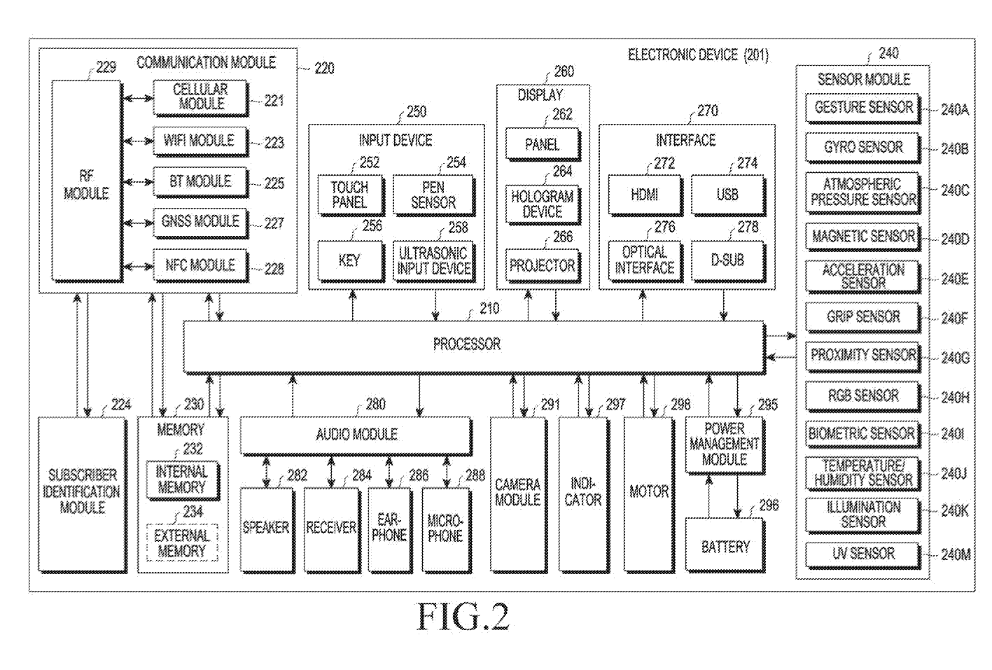

FIG. 2 is a block diagram of an electronic device 201 according to various embodiments of the present disclosure. The electronic device 201 may form the entire electronic device 101 illustrated in FIG. 2 or a part of the electronic device 101 illustrated in FIG. 1. The electronic device 201 may include one or more processors (e.g., application processors (APs)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 controls multiple hardware or software components connected to the processor 210 by driving an operating system (OS) or an application program, and performs processing and operations with respect to various data. The processor 210 may be implemented with, for example, a system on chip (SoC).

According to an embodiment of the present disclosure, the server 210 may include a graphic processing unit (GPU) and/or an image signal processor. The processor 210 may include at least some of the elements illustrated in FIG. 2 (e.g., the cellular module 221). The processor 210 loads an instruction or data received from at least one of other elements (e.g., a non-volatile memory) into a volatile memory to process the instruction or data, and stores result data in the non-volatile memory.

According to an embodiment of the present disclosure, the processor 210 may display a user interface corresponding to contents on a touch screen (e.g., the touch panel 252) to allow the user interface to be controlled through the touch screen, and display the user interface on at least a partial area of the touch screen to allow the user interface to be controlled through a sensor when determining through the touch screen that at least a part of the touch screen is located under water.

According to various embodiments of the present disclosure, the processor 210 may provide a first user interface corresponding to the touch panel 252, determine whether at least a part of the electronic device 201 (or a touch screen) is located under water, and provide a second user interface corresponding to the biometric sensor 240I when determining that the at least a part of the electronic device 201 is located under water. For example, when detecting a fingerprint through the biometric sensor 240I, the processor 210 may identify an input form or direction of a finger by analyzing a fingerprint image corresponding to the detected fingerprint, and identify the detected fingerprint as a user input such as a touch, a drag, a swipe, a pinch in/out, etc., based on the identified input form or direction. The processor 120 may perform a function corresponding to the identified first input.

The communication module 220 may have a configuration that is the same as or similar to the communication interface 170. The communication module 220 may include, for example, the cellular module 221, a WiFi module 223, a Bluetooth (BT) module 225, a GNSS module 227, a near field communication (NFC) module 228, and a radio frequency (RF) module 229. The cellular module 221 may provide, for example, a voice call, a video call, a text service, or an Internet service over a communication network. According to an embodiment of the present disclosure, the cellular module 221 may identify and authenticate the electronic device 201 in a communication network by using the SIM 224 (e.g., a SIM card). According to an embodiment of the present disclosure, the cellular module 221 may perform at least one of functions that may be provided by the processor 210. According to an embodiment of the present disclosure, the cellular module 221 may include a communication processor (CP). According to some embodiment, at least some (e.g., two or more) of the cellular module 221, the WiFi module 223, the BT module 225, the GNSS module 227, and the NFC module 228 may be included in one integrated chip (IC) or IC package. The RF module 229 may, for example, transmit and receive a communication signal (e.g., an RF signal). The RF module 229 may include a transceiver, a power amp module (PAM), a frequency filter, a low noise amplifier (LNA), at least one antenna, or the like. According to another embodiment of the present disclosure, at least one of the cellular module 221, the WiFi module 223, the BT module 225, the GNSS module 227, or the NFC module 228 may transmit and receive an RF signal through the separate RF module. The SIM 224 may, for example, include a card including a SIM or an embedded SIM, and may include unique identification information (e.g., an integrated circuit card identifier (ICCID)) or subscriber information (e.g., an international mobile subscriber identity (IMSI)).

The memory 230 (e.g., the memory 130) may, for example, include an internal memory 232 and/or an external memory 234. The internal memory 232 may, for example, include at least one of a volatile memory (e.g., dynamic random access memory (DRAM), static RAM (SRAM), synchronous dynamic RAM (SDRAM), etc.), or a non-volatile memory (e.g., one time programmable read only memory (OTPROM), programmable ROM (PROM), erasable and programmable ROM (EPROM), electrically erasable and programmable ROM (EEPROM), mask ROM, flash ROM, a flash memory, and a solid state drive (SSD), etc.). The external memory 234 may further include a flash drive, for example, compact flash (CF), secure digital (SD), micro-SD, mini-SD, extreme Digital (xD), a multi-media card (MMC), or a memory stick. The external memory 234 may be functionally or physically connected with the electronic device 201 through various interfaces.

The sensor module 240 measures physical quantity or senses an operation state of the electronic device 201 to convert the measured or sensed information into an electric signal. The sensor module 240 may, for example, include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., red/green/blue (RGB) sensor), a biometric sensor 240I, a temperature/humidity sensor 240J, an illumination sensor 240K, and an ultraviolet (UV) sensor 240M. Additionally or alternatively, the sensor module 240 may include an E-nose sensor (not shown), an electromyography (EMG) sensor (not shown), an electroencephalogram (EEG) sensor (not shown), an electrocardiogram (ECG) sensor (not shown), an infrared (IR) sensor, an iris sensor, and/or a fingerprint sensor. The sensor module 240 may further include a control circuit for controlling at least one sensor included therein. In some embodiment, the electronic device 201 may further include a processor configured to control the sensor module 240 as part of or separately from the processor 210, to control the sensor module 240 during a sleep state of the processor 210.

The input device 250 may include, for example, a touch panel 252, a (digital) pen sensor 254, a key 256, or an ultrasonic input device 258. The touch panel 252 may use at least one of a capacitive type, a resistive type, an IR type, or an ultrasonic type. The touch panel 252 may further include a control circuit. The touch panel 252 may further include a tactile layer to provide tactile reaction to the user. The (digital) pen sensor 254 may include a recognition sheet which is a part of the touch panel 252 or a separate recognition sheet. The key 256 may also include a physical button, an optical key, or a keypad. The ultrasonic input device 258 senses ultrasonic waves generated by an input means through a microphone (e.g., the microphone 288) and checks data corresponding to the sensed ultrasonic waves.

The display 260 (e.g., the display 160) may include a panel 262, a hologram device 264, a projector 266, and/or a control circuit for controlling them. The panel 262 may be implemented to be flexible, transparent, or wearable. The panel 262 may be configured with the touch panel 252 in one module. According to an embodiment of the present disclosure, the panel 262 may include a pressure sensor (or a “force sensor”) capable of measuring a strength of a pressure by a user's touch. The pressure sensor may be implemented integrally with the touch panel 252 or may be implemented as one or more sensors separate from the touch panel 252. The hologram device 264 may show a stereoscopic image in the air by using interference of light. The projector 266 may display an image onto a screen through projection of light. The screen may be positioned inside or outside the electronic device 201. The interface 270 may include an HDMI 272, a USB 274, an optical interface 276, or a D-subminiature (D-sub) 278. The interface 270 may be included in the communication interface 170 illustrated in FIG. 1. Additionally or alternatively, the interface 270 may include a mobile high-definition link (MHL) interface, an SD/multi-media card (MMC) interface, or an Infrared Data Association (IrDA) interface.

The audio module 280 may bi-directionally convert sound and an electric signal. At least one element of the audio module 280 may be included in the I/O interface 145 illustrated in FIG. 1. The audio module 280 may process sound information input or output through the speaker 282, the receiver 284, the earphone 286, or the microphone 288.

The camera module 291 may be, for example, a device capable of capturing a still image or a moving image, and according to an embodiment, may include one or more image sensors (e.g., a front sensor or a rear sensor), a lens, an image signal processor (ISP), or a flash (e.g., an LED, a xenon lamp, etc.).

The power management module 295 may manage power of the electronic device 201. According to an embodiment of the present disclosure, the power management module 295 may include a power management integrated circuit (PMIC), a charger IC, or a battery fuel gauge. The PMIC may have a wired and/or wireless charging scheme. The wireless charging scheme includes a magnetic-resonance type, a magnetic induction type, and an electromagnetic type, and for wireless charging, an additional circuit, for example, a coil loop, a resonance circuit, or a rectifier may be further included. The battery gauge may measure the remaining capacity of the battery 296 or the voltage, current, or temperature of the battery 296 during charging. The battery 296 may include, for example, a rechargeable battery and/or a solar battery.

The indicator 297 displays a particular state, for example, a booting state, a message state, or a charging state, of the electronic device 201 or a part thereof (e.g., the processor 210). The motor 298 may convert an electric signal into mechanical vibration or generates vibration or a haptic effect. The electronic device 201 may include a device for supporting the mobile TV (e.g., a GPU) to process media data according to a standard such as digital multimedia broadcasting (DMB), digital video broadcasting (DVB), or mediaFlo™. Each of the foregoing elements described herein may be configured with one or more components, names of which may vary with a type of the electronic device. In various embodiments of the present disclosure, some components of the electronic device (e.g., the electronic device 201) may be omitted or may further include other elements, and some of the components may be coupled to form one entity and identically perform functions of the components before being coupled.

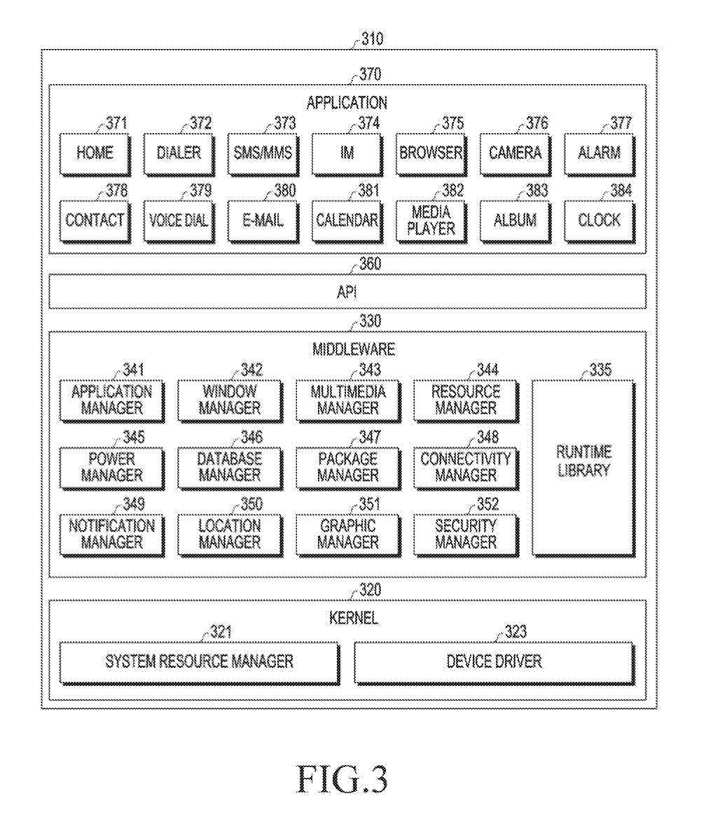

FIG. 3 is a block diagram of a programming module according to various embodiments of the present disclosure. According to an embodiment, a programming module 310 (e.g., the program 140) may include an OS for controlling resources associated with an electronic device (e.g., the electronic device 101) and/or various applications (e.g., the application program 147) executed on the OS. The OS may include Android™, iOS™, Windows™, Symbian™, Tizen™, or Bada™. Referring to FIG. 3, the programming module 310 may include a kernel 320 (e.g., the kernel 141), middleware 330 (e.g., the middleware 143), an application programming interface (API) 360 (e.g., the API 145), an application 370 (e.g., the application program 147), or/and a location providing module 380. At least a part of the programming module 310 may be preloaded on an electronic device or may be downloaded from an external device (e.g., the electronic device 102 or 104, or the server 106).

The kernel 320 may include a system resource manager 321 and/or a device driver 323. The system resource manager 321 may perform control, allocation, retrieval of system resources, and so forth. According to an embodiment of the present disclosure, the system resource manager 321 may include a process management unit, a memory management unit, or a file system management unit. The device driver 323 may include, for example, a display driver, a camera driver, a Bluetooth driver, a shared memory driver, a USB driver, a keypad driver, a WiFi driver, an audio driver, or an inter-process communication (IPC) driver. The middleware 330 may include provide functions that the application 370 commonly requires or provide various functions to the application 370 through the API 360 to allow the application 370 to use a limited system resource in an electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses to add a new function through a programming language while the application 370 is executed. The runtime library 335 performs input/output management, memory management, or calculation function processing. The application manager 341 may manage a life cycle of the applications 370. The window manager 342 may manage a graphic user interface (GUI) resource used in a screen. The multimedia manager 343 may recognize a format necessary for playing media files and perform encoding or decoding on a media file by using a codec appropriate for a corresponding format. The resource manager 344 may manage a source code or a memory space of the applications 370. The power manager 345 may manage a battery or power and provide power information necessary for an operation of the electronic device. According to an embodiment of the present disclosure, the power manager 345 may operate with basic input/output system (BIOS). The database manager 346 may generate, search or change a database used for at least one application among the applications 370. The package manager 347 may manage the installation or update of an application distributed in a package file format.

The connectivity manager 348 may manage a wireless connection. The notification manager 349 may provide an event, e.g., an arriving message, an appointment, proximity notification, etc. The location manager 350 may manage location information about an electronic device. The graphic manager 351 may manage, for example, a graphic effect to be provided to a user or a user interface relating thereto. The security manager 352 may provide, for example, system security or user authentication. According to an embodiment of the present disclosure, the middleware 330 may further include a telephony manager for managing a voice or video call function of the electronic device or a middleware module forming a combination of functions of the above-described components. According to an embodiment, the middleware 330 provides a module specified for each type of an OS. Additionally, the middleware 330 may delete some of existing elements or add new elements dynamically. The API 360 may be provided as a set of API programming functions with a different configuration according to the OS. In the case of Android or iOS, for example, one API set may be provided by each platform, and in the case of Tizen, two or more API sets may be provided.

The application 370 may include one or more applications capable of providing a function, for example, a home application 371, a dialer application 372, a short messaging service/multimedia messaging service (SMS/MMS) application 373, an instant message (IM) application 374, a browser application 375, a camera application 376, an alarm application 377, a contact application 378, a voice dial application 379, an e-mail application 380, a calendar application 381, a media player application 382, an album application 383, a clock application 384, a health care application (e.g., an application for measuring an exercise amount, a blood sugar, etc.), or an environment information providing application (e.g., an application for providing air pressure, humidity, or temperature information or the like). According to an embodiment, the application 370 may include an information exchange application supporting information exchange between the electronic device and an external electronic device. The information exchange application may include, for example, a notification relay application for transferring specific information to the external electronic device or a device management application for managing the external electronic device. For example, the notification relay application may deliver notification information generated in another application of the electronic device to an external electronic device or may receive notification information from the external electronic device and provide the notification information to the user. The device management application may manage (e.g., install, remove, or update) a function (e.g., turn on/turn off of an external electronic device itself (or a part thereof) or control of brightness (or resolution) of a display) of an external device communicating with the electronic device, a service provided by an application operating in an external electronic device or provided by the external electronic device (e.g., a call service or a message service). According to an embodiment, the application 370 may include an application (e.g., device health care application of mobile medical equipment) designated according to an attribute of the external electronic device. According to an embodiment, the application 370 may include an application received from the external electronic device.

The at least a part of the programming module 310 may be implemented (e.g., executed) by software, firmware, hardware (e.g., the processor 210), or a combination of two or more of them, and may include, for example, modules, programs, routines, sets of instructions, or processes for performing one or more functions.

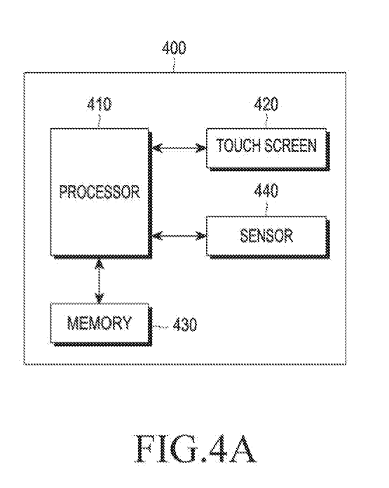

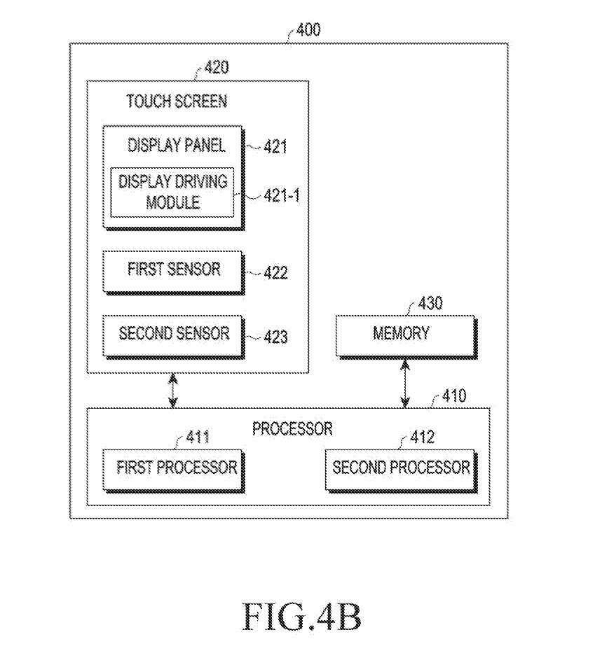

FIGS. 4A and 4B are block diagrams of an electronic device according to various embodiments of the present disclosure.

Referring to FIG. 4A, an electronic device 400 (e.g., the electronic device 101 or 201) may include a processor 410 (e.g., the processor 120 or 210), a touch screen 420 (e.g., the display 160 or the touch panel 252), a memory 430 (e.g., the memory 130 or 230), and a sensor 440 (e.g., the sensor module 180 or 240).

According to an embodiment of the present disclosure, the processor 410 may display a user interface corresponding to contents on the touch screen 420 to allow the user interface to be controlled through the touch screen 420, and display the user interface on at least a partial area of the touch screen 420 to allow the user interface to be controlled through the sensor 440 when determining through the touch screen 420 that at least a part of the touch screen 420 is located under water. For example, the contents may include at least one application or at least one of an execution screen, a play screen, a reading screen, a preview screen, or the like of an application, music, a moving image, a camera, a document, etc. The user interface may include a graphic object including an execution or shortcut icon corresponding to at least one application or a graphic object including at least one of a controller, a scroll, a menu, etc., forming a screen (or included in a screen).

According to various embodiments of the present disclosure, the processor 410 may determine whether at least a part of the electronic device 400 (or the touch screen 420) is located under water, and display a user interface for controlling the contents displayed on the touch screen 420 on an area corresponding to the sensor 440 when determining that the at least a part of the electronic device 400 is located under water. When detecting a fingerprint input on an area corresponding to the sensor 440, the processor 410 may identify a fingerprint input as an input such as a touch, two touches, a drag, a swipe, a pinch in/out, etc., by analyzing the fingerprint input, and perform at least one function to correspond to the identified input.

According to various embodiments of the present disclosure, the processor 410 may determine whether the electronic device 400 is located under water, by using the touch sensor (or panel) included in the touch screen 420. For example, when detecting a touch input on the entire area detectable by the touch sensor or an area larger than or equal to a threshold size, the processor 410 may determine that the electronic device 400 is located under water.

According to various embodiments of the present disclosure, when detecting a fingerprint, the processor 410 may identify an input form or direction of a fingerprint by analyzing a fingerprint image corresponding to the detected fingerprint, and identify the detected finger as an input such as a touch, two touches, a drag, a swipe, a pinch in/out, etc., based on the identified input form or direction.

According to an embodiment of the present disclosure, the touch screen 420 may include a touch sensor (or panel), and may detect an input such as a touch, a drag, a long press, a swipe, a pinch in/out, etc., through an area detectable by the touch sensor. The touch screen 420 may display contents.

According to various embodiments of the present disclosure, when the processor 410 determines that the electronic device 400 is located under water, the touch screen 420 may display the second user interface corresponding to at least one application available under water or at least one of an execution screen, a play screen, a reading screen, a preview screen, etc., related to an application, music, a moving image, a camera, a document, etc. For example, the user interface may include a graphic object including a part of an execution or shortcut icon corresponding to at least one application or a graphic object including a part of an icon, a controller, a scroll, a menu, etc., forming a screen (or included in a screen).

According to an embodiment of the present disclosure, the memory 430 may store information for providing a user interface corresponding to the contents available under water. For example, the memory 430 may include a secure area that is safe from an external access in terms of hardware or software, and store a biometric template on the secure area. The biometric template may be used for user authentication using biometric information.

According to an embodiment of the present disclosure, the sensor 440 may detect an input (e.g., a fingerprint) on an area corresponding to the sensor 440. The sensor 440 may include at least one of an optical fingerprint sensor, an ultrasonic fingerprint sensor, or an optical sensor. For example, when the sensor 440 is an optical fingerprint sensor, the sensor 440 may capture a fingerprint image by using light emitted from a light source (e.g., the touch screen 420) and output the captured fingerprint image. When the sensor 440 is an ultrasonic fingerprint sensor, the sensor 440 may output ultrasonic waves and detect the fingerprint by using a path difference between ultrasonic waves reflected from a fingerprint surface (e.g., a valley and a ridge of the fingerprint). When the sensor 440 is an optical sensor, the sensor 440 may include a low-resolution image sensor and detect a shape or movement of the fingerprint by using the image sensor.

Referring to FIG. 4B, the electronic device 400 may include a processor 410, a touch screen 420, and a memory 430. The processor 410 may include a first processor 411 and a second processor 412.

According to an embodiment of the present disclosure, the processor 410 may operate in a normal mode, and determine whether the first input is detected on a first area corresponding to the first sensor 422. For example, the normal mode may be an operation mode in which the electronic device 400 provides the first user interface corresponding to the first sensor 422 and detects a user input by using the first sensor 422. The first user interface may include a graphic object corresponding to at least one application or at least one of an execution screen, a play screen, a reading screen, a preview screen, or the like related to an application, music, a moving image, a camera, a document, etc. The first area is an area where the first sensor 422 may detect the first input, and may correspond to at least a part of an active area (or a display area) (e.g., an area capable of displaying a user interface) of the display 421. The first input may include a touch, an approach, a drag, a swipe, a pinch in/out, hovering, etc., using an electronic pen or a user's body part.

When detecting the first input on at least a part of the first area through the first sensor 422, the processor 410 may perform an operation corresponding to the detected first input. For example, when detecting the touch input on at least a part of the first area corresponding to a first application execution icon (or a position thereof) through the first sensor 422, the processor 410 may display an execution screen of a first application corresponding to the first application execution icon on the display 421.

According to various embodiments of the present disclosure, upon receiving a touch input for executing a first application through the first user interface corresponding to the contents through the first sensor 422, the processor 410 may display a first application execution screen on the display 421. For example, the first user interface corresponding to the contents may include a graphic object corresponding to an execution screen related to the first application.

When determining through the first sensor 422 that the electronic device 400 is located under water, the processor 410 may deactivate the first sensor 422 and activate the second sensor 423. The processor 410 may display the second user interface corresponding to contents related to a second area of the second sensor 423 on the display 421. For example, the second user interface corresponding to the contents may include at least a part of a graphic object rearranged corresponding to the first application execution screen.

According to an embodiment of the present disclosure, the processor 410 may determine through the first sensor 422 whether at least a part of the electronic device 400 (or the touch screen 420) is located under water. According to various embodiments of the present disclosure, the processor 410 may determine whether the electronic device 400 is located under water, by using various methods as well as the first sensor 420. Such a method is not limited to the embodiments, and may be implemented using various methods for determining whether the electronic device 400 is located under water.

According to various embodiments of the present disclosure, the processor 410 may determine that the electronic device 400 is located under water when attenuation of an RF signal occurs.

According to various embodiments of the present disclosure, the processor 410 may further include a humidity sensor (e.g., a capacitive humidity sensor), and may determine that the electronic device 400 is located under water when a capacitance of the humidity sensor increases over a preset value due to adsorptive power of water molecules.

According to an embodiment of the present disclosure, when determining that the electronic device 400 is located under water, the processor 410 may deactivate the first sensor 422 and activate the second sensor 423 to display the second user interface corresponding to the activated second sensor 423 on the display 421. The second user interface may be configured to include at least a part of the first user interface. For example, the second user interface may include at least a part of a graphic object including at least one of an execution or shortcut icon, a controller, a scroll, a menu, etc., corresponding to the contents, a graphic object corresponding to contents available under water, or at least a part of a rearranged graphic object. The processor 410 may rearrange at least a part of a graphic object corresponding to the contents related to the second area of the second sensor 423.

According to various embodiments of the present disclosure, when determining that the electronic device 400 is located under water, the processor 410 may enter an under-water mode to activate the second sensor 423 and display the second user interface corresponding to the second area of the second sensor 423 on the display 421. For example, the under-water mode is an operation mode where the electronic device 400 provides at least one function available under water, and in the under-water mode, the processor 410 may provide the second user interface related to the second sensor 423 and detect the second input by using the second sensor 423. The second area is an area where the second sensor 423 may detect the second input (e.g., the user input), and may include one or more areas and correspond to at least a part of the first area. The second area may be equal to the first area in size, or at least a part of the second area may be included in at least a part of the first area.

According to various embodiments of the present disclosure, the processor 410 may display the second user interface corresponding to contents available under water in relation to the second area on the display 421. The second user interface may include an execution icon corresponding to at least one application.

Upon detecting the second input with respect to the first application execution icon among at least one application icon through the second area, the processor 410 may display the first application execution screen on the display 421. Upon detecting the second input with respect to an object (e.g., a menu, an icon, etc.) corresponding to at least one function on the first application execution screen, the processor 410 may perform at least one function related to the first application.

According to various embodiments of the present disclosure, upon detecting (or receiving) the second input (e.g., a fingerprint) through the second area, the processor 410 may analyze the detected fingerprint and identify the detected fingerprint as an input such as a touch, two touches, a drag, a swipe, a pinch in/out, etc. For example, the processor 410 may obtain a plurality of fingerprint images of the detected fingerprint and generate an image where the obtained fingerprint images are sequentially accumulated. The processor 410 may identify an input form or direction of a finger by analyzing the generated accumulation image, and identify the detected fingerprint as an input such as a touch, two touches, a drag, a swipe, a pinch in/out, etc., based on the identified input form or direction.

According to various embodiments of the present disclosure, the processor 410 may determine whether at least a part of the electronic device 400 is located under water, by periodically activating the first sensor 422 in the under-water mode. When the at least a part of the electronic device 400 is located under water, the processor 410 may deactivate the first sensor 422 and continuously maintain the under-water mode. When the at least a part of the electronic device 400 is not located under water, the processor 410 may deactivate the second sensor 423 and execute (or change) the normal mode for detecting the first input by using the activated first sensor 422.

According to various embodiments of the present disclosure, a user operation under water is slower than a user operation outside water, such that when detecting a fingerprint in a shorter time than a first time designated in the second area, the processor 410 may determine that the detected fingerprint is an invalid input, and ignore the detected fingerprint.

According to various embodiments of the present disclosure, the processor 410 may change feature information (e.g., a size, a location, a shape, etc.) regarding the second area of the second sensor 423, in the under-water mode. For example, the processor 410 may set a detection area having a rectangular shape with a long width or height, or grid shape to the second area of the second sensor 423. The processor 410 may activate one of a plurality of detection areas and deactivate another one of the plurality of detection areas to set the activated one detection area as the second area of the second sensor 423.

According to various embodiments of the present disclosure, the processor 410 may change a resolution of the second area of the second sensor 423 in the under-water mode. For example, the processor 410 may activate some of a plurality of detection pixels included in the second sensor 423. The processor 410 may divide the plurality of detection pixels into a total of four units including 2×2 (horizontally and vertically) units, and may sequentially activate or deactivate for each of the four divided detection pixels. As a resolution of the fingerprint image of the detected fingerprint may be reduced to ¼ through some activated detection pixels, the fingerprint image may be processed at higher speed.

According to various embodiments of the present disclosure, the processor 410 may change an image processing scheme of the second sensor 423 in the under-water mode. As the processor 410 does not need to extract feature information (e.g., a curve, a feature point, etc.) of the detected fingerprint, the fingerprint image may be processed faster by reducing or removing the amount of information such as a resolution, a contrast, etc., of the fingerprint image of the detected fingerprint. For example, the processor 410 may change color information or grayscale information of the fingerprint image into black and white (BW) information and perform processing with respect to the fingerprint image faster. The processor 410 may convert the fingerprint image into another piece of information. For example, the processor 410 may calculate a central point with respect to the entire area of the fingerprint image and change the fingerprint image into coordinates of the calculated central point.

According to various embodiments of the present disclosure, the processor 410 may change an image capturing speed of the second sensor 423 in the under-water mode. The processor 410 may set a speed of capturing the fingerprint image by the second sensor 423 to a higher speed to detect an input form (or gesture) or direction of a finger fast. For example, when the speed of capturing the fingerprint image by the second sensor 423 is basically 5 frames/sec, the processor 410 may change the capturing speed of the second sensor 423 into 20 frames/sec in the under-water mode. In this way, with a higher capturing speed of the second sensor 423, motion of the finger may be captured fast.

According to various embodiments of the present disclosure, the processor 410 may change an image capturing frequency of the second sensor 423 in the under-water mode. Generally, the second sensor 423 (e.g., the fingerprint sensor or the optical sensor) may perform fingerprint registration or fingerprint authentication upon receiving a trigger signal for activating the fingerprint sensor in fingerprint registration or fingerprint authentication, and may be deactivated upon completion of fingerprint registration or fingerprint authentication. The processor 410 may periodically deliver a trigger signal for activation to the second sensor 423 such that the second sensor 423 may be continuously maintained activated after completion of capturing of the fingerprint image in the under-water mode.

According to various embodiments of the present disclosure, the processor 410 may display the second user interface corresponding to contents related to the second area of the second sensor 423 on the display 430, or download the second user interface through a server (or a cloud).

According to various embodiments of the present disclosure, the first processor 411 may control the overall operation of the electronic device 400.

According to various embodiments of the present disclosure, the second processor 412 may include a low-power processor or sensor hub, and may control the touch screen 420 independently of the first processor 411 when the electronic device 400 is in a sleep mode. The sleep mode may be an operation mode where only minimum elements (e.g., the second processor 412 and the first sensor 422 or the second sensor 423) included in the electronic device 400 operate (or are supplied with power), and the other elements do not operate (or are not supplied with power). For example, in the sleep mode, the second processor 412 may process the first input (e.g., a touch input, etc.) detected through the first sensor 422 or the second input (e.g., a fingerprint input, etc.) detected through the second sensor 423.

According to various embodiments of the present disclosure, the first processor 411 or the second processor 412 may perform at least some operation identical to that of the processor 410 described with reference to FIG. 4A. For example, the first processor 411 or the second processor 412 may determine using the first sensor 422 whether at least a part of the electronic device 400 is located under water, and may display the second user interface corresponding to the second sensor 423 on the touch screen 420 when determining that at least a part of the electronic device 400 is located under water.

According to an embodiment of the present disclosure, the touch screen 420 may include a display 421, a first sensor 422, and a second sensor 423.

According to an embodiment of the present disclosure, the display 421 may display a first user interface and a second user interface which correspond to contents. For example, the first user interface may include an execution icon corresponding to at least one application or a menu or an icon on the first application execution screen where a particular application is executed. The menu or icon may correspond to at least one function related to the first application. The second user interface may include an execution icon corresponding to an application available under water among a plurality of applications or include a menu or an icon corresponding to some of at least one function on a particular application execution screen.

According to various embodiments of the present disclosure, the display 421 may include a plurality of pixels and a display driving module (e.g., a display driver integrated circuit (DDI)) 421-1 that is configured to control at least some of the plurality of pixels to provide display information. The display driving module 421-1 may drive (or activate) the display 421 in response to the first input detected by the first sensor 422 or the second input detected by the second sensor 423.

According to an embodiment of the present disclosure, the first sensor 422 may include at least one sensor that detects the first input such as a touch, a gesture, an approach, a drag, a swipe, a pinch in/out, hovering, etc., using an electronic pen or a user's body part. For example, the first sensor 422 may include a capacitive sensor, etc.

According to an embodiment of the present disclosure, the second sensor 423 may include at least one sensor that detects (or obtains) the second input such as biometric information such as a fingerprint, etc. For example, the second sensor 423 may include an optical sensor, an ultrasonic sensor, etc. When the second sensor 423 is an optical sensor, the second sensor 423 may capture a fingerprint image by using light output from the display 421 as a light source, and output the captured fingerprint image.

According to various embodiments of the present disclosure, the second sensor 423 may be activated by the processor 410 when the processor 410 determines that at least a part of the electronic device 400 is located under water. The second sensor 423 may detect one fingerprint or a plurality of fingerprints through the second area, and output a fingerprint image of one detected fingerprint or fingerprint images of a plurality of detected fingerprints. For example, the under-water mode may be an operation mode allowing the electronic device 400 to perform functions available under water.

According to various embodiments of the present disclosure, the first sensor 422 and the second sensor 423 may perform at least some operations identical to that of the touch sensor and the sensor 440 described with reference to FIG. 4A. For example, the first sensor 422 may detect the first input in the first area, and the second sensor 423 may detect the second input in the second area. Once the display 421 is driven (or activated) in response to the first input or the second input, the first sensor 422 or the second sensor 423 may obtain (or capture) biometric information (e.g., a fingerprint image, an iris image, etc.) by using light output from the display 421 as a light source.

According to an embodiment of the present disclosure, the memory 430 may store information for providing a first user interface corresponding to the contents related to the first sensor 422 in the normal mode. The memory 430 may store information for providing the second user interface corresponding to the contents related to the sensor 423 in the under-water mode. The memory 430 may store result information (e.g., a biometric template) of processing of biometric information such as a fingerprint, an iris, etc., for example, feature point extraction, deformation, encryption, etc.

According to various embodiments of the present disclosure, the memory 430 may perform at least some operations identical to that of the processor 430 described with reference to FIG. 4A. For example, the memory 430 may include the first area that stores the information used to provide the user interface and the second area (e.g., the secure area) that stores biometric information (e.g., the biometric template) for user authentication.

According to various embodiments of the present disclosure, the electronic device 400 may include the sensor 440 formed in at least a partial area of the touch screen 420 and the processor 410, and the processor 410 may display a user interface corresponding to contents on the touch screen 420 to allow the user interface to be controlled through the touch screen 420, and may display the user interface on at least a partial area of the touch screen 420 to allow the user interface to be controlled through the sensor 440 when determining through the touch screen 420 that at least a part of the touch screen 420 is located under water.

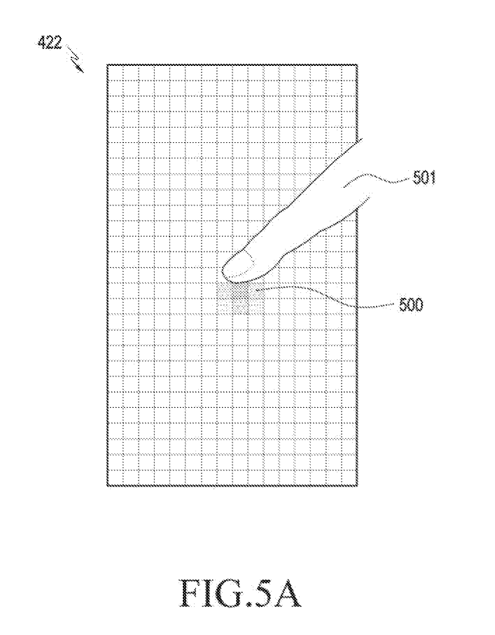

FIGS. 5A, 5B, and 5C show examples for describing a method of determining whether an electronic device is located under water through a first sensor, according to various embodiments of the present disclosure.

According to various embodiments of the present disclosure, the first sensor 422 may include 15×27 (horizontally and vertically) capacitive sensors (e.g., a total of 405 capacitive sensors). These sensors may usually have a raw capacitance (e.g., a capacitance value) between −3˜6 farads (F). The number of sensors is an exemplary value, and may be implemented variously.

Referring to FIG. 5A, the first sensor 422 may deliver a detection signal (or a measurement signal) to the processor 410 when a raw capacitance change that is greater than or equal to a threshold value is detected (or measured) in a particular area 500. The processor 410 may determine based on the received detection signal (or measurement signal) that the first input (e.g., a normal touch input) is detected in the particular area 500. For example, when a size of the particular area 500 a user's finger 501 contacts (or touches) is 10 phi, the first sensor 422 may measure a raw capacitance of about 258 farads; when the size of the particular area 500 the user's finger 501 contacts (or touches) is 4 phi, the first sensor 422 may measure a raw capacitance of about 194 farads. According to various embodiments of the present disclosure, when a raw capacitance of about 258 farads is measured in the particular area 500 through the first sensor 422, the processor 410 may determine that the first input is detected in the particular area 500.

Referring to FIGS. 5B and 5C, the first sensor 422 may deliver a detection signal (or a measurement signal) to the processor 410 when a raw capacitance change that is greater than or equal to a threshold value is detected (or measured) in the entire area 510 or an area 520 having a size larger than or equal to a preset size in the first sensor 422. The processor 410 may determine based on the received detection signal (or measurement signal) that the second input (e.g., an abnormal touch input) is detected in the entire area 510 or the area 520 having the size larger than or equal to the preset size. For example, when the electronic device 400 is located under water, the first sensor 422 may measure a raw capacitance of about 258 farads or higher in the entire area 510 or the area 520 having the size larger than or equal to the preset size. According to various embodiments of the present disclosure, when a raw capacitance of about 258 farads or higher is measured in the entire area 510 or the area 520 having the size larger than or equal to the preset size through the first sensor 422, the processor 410 may determine that the second input is detected in the particular area 500.

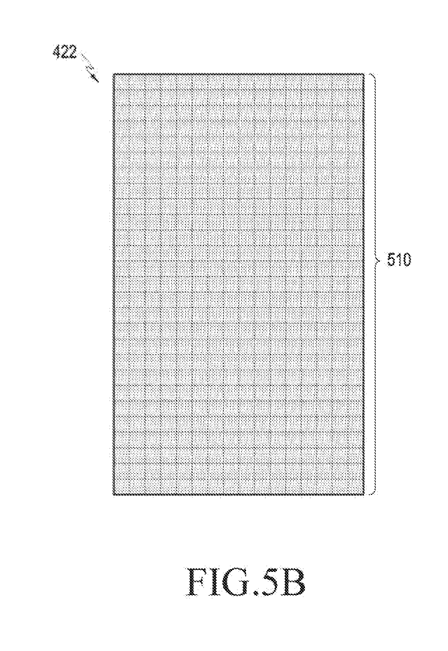

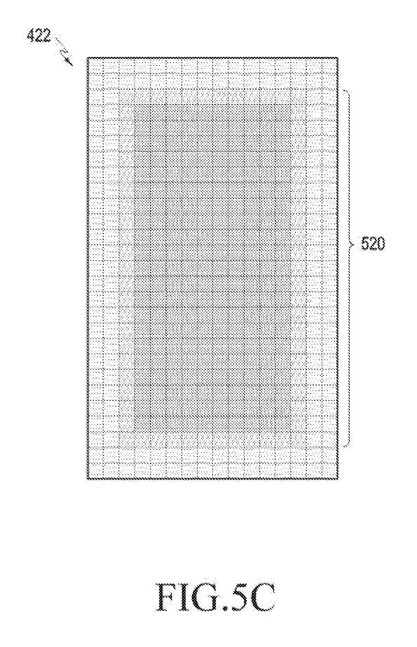

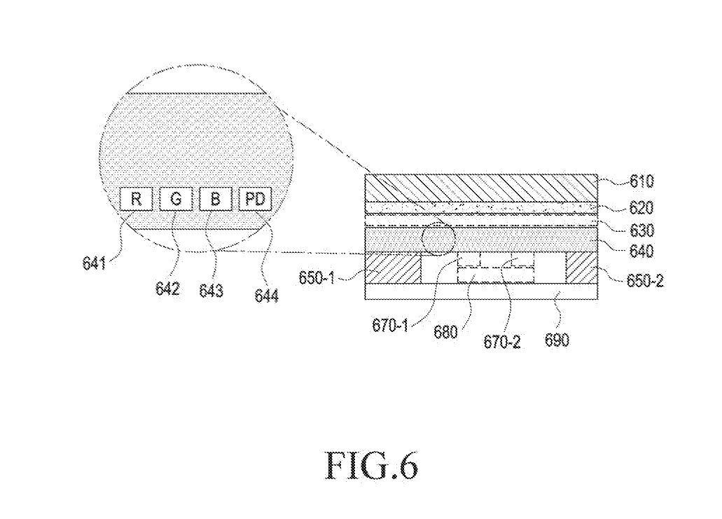

FIG. 6 is a block diagram showing a structure of a touch screen according to various embodiments of the present disclosure.

Referring to FIG. 6, a touch screen 600 (e.g., the touch screen 420 of FIG. 4) may include a first sensor 630 and a second sensor 680 in at least a partial area of the touch screen 600.

According to an embodiment of the present disclosure, the touch screen 600 may include glass 610, a first sensor 630, a display 640, a second sensor 680, or a printed circuit board (PCB) 690. The glass 610 may be adhered to the first sensor 630 or the display 640 through an adhesive 620. The touch screen 600 may further include structures 650-1 and 650-2 for securing a mounting space of the second sensor 680. The structures 650-1 and 650-2 may form at least a part of a sealing structure for protecting the second sensor 680.

According to an embodiment of the present disclosure, the first sensor 630 and the second sensor 680 may be formed in a partial area e.g., one area or a plurality of areas) of the display 640 or an entire area (e.g., an active area) of the display 640. For example, the first sensor 630 may be formed on a separate layer on a surface of the display 640, and the second sensor 680 may be formed on another surface (e.g., a back surface) of the display 640.

According to an embodiment of the present disclosure, the display 640 may form the second sensor 680 (or a third sensor module 644) on a surface (e.g., a top surface (e.g., at least a partial area of a surface where pixels 641 through 643 of the display 640 are formed)). For example, the second sensor 680 (or the third sensor module 644) may include any one of an optical sensor or an ultrasonic sensor.

According to an embodiment of the present disclosure, the first sensor 630 and the second sensor 680 may include at least one of an optical sensor (e.g., an optical image sensor), an ultrasonic sensor (e.g., an ultrasonic transmission/reception module), or a capacitive sensor (e.g., a capacitive transmission/reception electrode pattern). For example, the first sensor 630 may be formed as a capacitive transmission/reception electrode pattern, and the second sensor 680 may be formed as at least one of an optical image sensor or an ultrasonic transmission/reception module. The optical image sensor may output light (e.g., visible light rays, infrared rays, or ultraviolet rays) emitted from a light source (e.g., the display 640 or an infrared (IR) light emitting diode (LED)), and detect light reflected from a user's fingerprint.

According to various embodiments of the present disclosure, the first sensor 630 may be formed between the adhesive layer 620 and the display 640 or between the window glass 610 and the adhesive layer 620. For example, the first sensor 630 may be formed as a transparent electrode to improve a transmissivity of light output from the display 640.

According to various embodiments of the present disclosure, elastic bodies 670-1 and 670-2 (e.g., a sponge, rubber, etc.) may be formed between the second sensor 680 and the display 640 to relieve an impact or prevent introduction of a foreign material therebetween.

According to various embodiments of the present disclosure, the first sensor 630 and the second sensor 680 (or the third sensor module 644) may be arranged by being printed on or etched to a surface of a cover glass on the display 640 (e.g., an in/on-cover glass structure).

According to various embodiments of the present disclosure, the first sensor 630 and the second sensor 680 (or the third sensor module 644) may be arranged on the display 640 (e.g., an over-display structure).

According to various embodiments of the present disclosure, the first sensor 630 and the second sensor 680 (or the third sensor module 644) may be arranged under the display 640 (e.g., an under-display structure).

According to various embodiments of the present disclosure, the first sensor 630 and the second sensor 680 (or the third sensor module 644) may be arranged inside pixels of the display 640 or in a black matrix (BM) area between one pixel and another pixel (e.g., an in-display structure).

According to various embodiments of the present disclosure, a capacitive sensor may detect a fingerprint by using a method in which a first area (e.g., a ridge) is detected where a finger surface contacts an electrode and a second area (e.g., a valley) is not detected where the finger surface does not contact the electrode. The optical sensor may capture the finger surface by using a photosensitive diode and obtain a fingerprint image from a captured image. The ultrasonic sensor may generate and output ultrasonic waves by using a piezo scheme, and detect a fingerprint by using a path difference between ultrasonic waves reflected from the finger surface. These sensors may detect the fingerprint by using various schemes, and may not be limited as described in the embodiments.

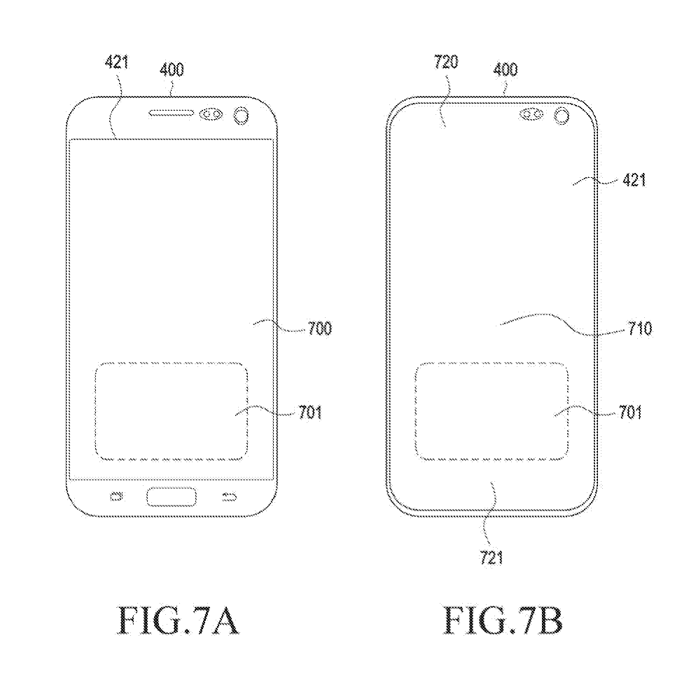

FIGS. 7A and 7B show examples for describing an active area of a display according to various embodiments of the present disclosure.

Referring to FIG. 7A, the display 421 may include an active area 700 for displaying the first user interface. For example, the active area 700 may correspond to an entire size of the display 421. The display 421 may include the first area of the first sensor 422 or the second area of the second sensor 423 to correspond to at least a partial area 701 of the active area 700. The first sensor 422 or the second sensor 423 may be positioned corresponding to at least a partial area 401. For example, the first sensor 422 or the second sensor 423 may be located on a surface of the display 421 or under a back surface of the display 421 or may be formed in a BM area between pixels.

Referring to FIG. 7B, the display 421 may include an active area 710 to include the first area or the second area. For example, the display 421 may include the first sensor 422 or the second sensor 423 in the at least a partial area 701 of the display 421. In this case, the first area or the second area is included in the at least a partial area 701 of the active area 700, such that the display 421 may expand the size of the active area 700 to an upper end 720 and a lower end 721 of the electronic device 400 as largely as the size of the first area or the second area.

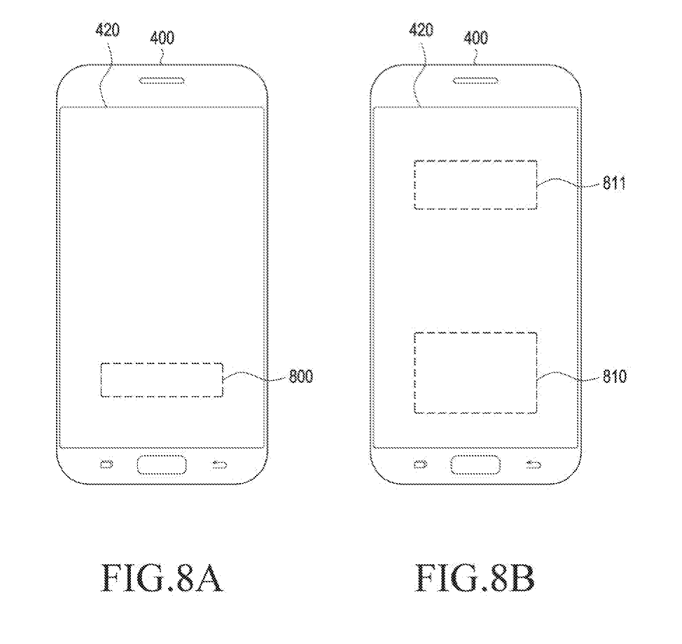

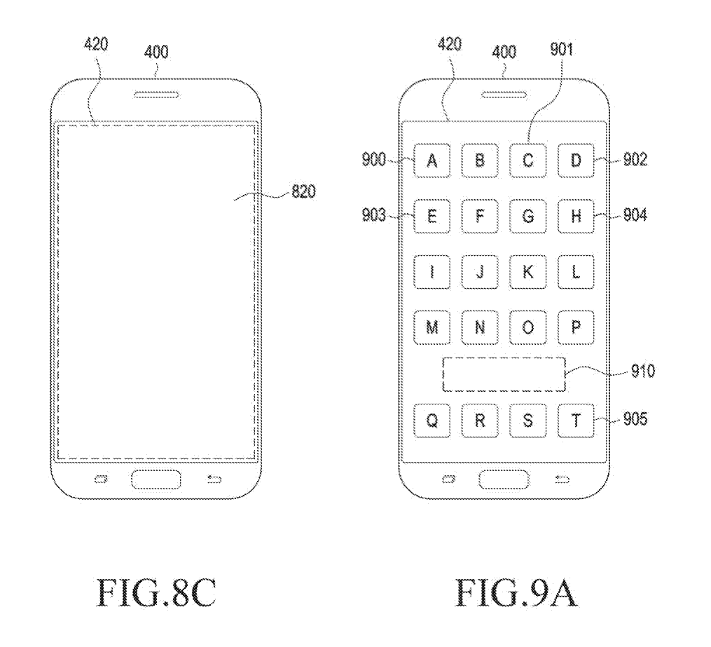

FIGS. 8A, 8B, and 8C show examples of a second area of a second sensor according to various embodiments of the present disclosure.

Referring to FIG. 8A, the second sensor 423 may include a second area 800 corresponding to a partial area of the touch screen 420 of the electronic device 400. For example, when the second sensor 423 is formed in a first position of the touch screen 420, the second sensor 423 may include a second area 800 corresponding to the first position.

Referring to FIG. 8B, the second sensor 423 may include a plurality of second areas (e.g., a first area 810 and a second area 811) corresponding to a plurality of areas of the touch screen 420. For example, when the second sensor 423 is formed in each of a plurality of partial areas of the touch screen 420, the second sensor 423 may include second areas 810 and 811 corresponding to respective positions (and sizes) of the plurality of partial areas.

Referring to FIG. 8C, the second sensor 423 may include a second area 820 corresponding to the entire area of the touch screen 420. For example, when the second sensor 423 is formed in the entire area of the touch screen 420, the second sensor 423 may include a second area 820 having a size corresponding to the entire area of the touch screen 420.

According to various embodiments of the present disclosure, the second area 820 may correspond to a first size formed in the second sensor 423 or may have a second size larger than the first size. For example, the second sensor 423 may include the second area 820 having various sizes according to a magnitude of power used in the second sensor 423.

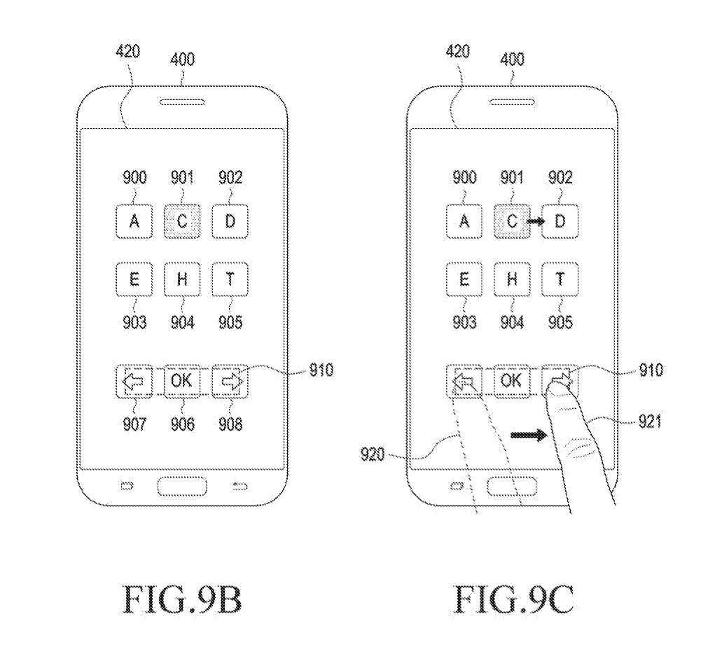

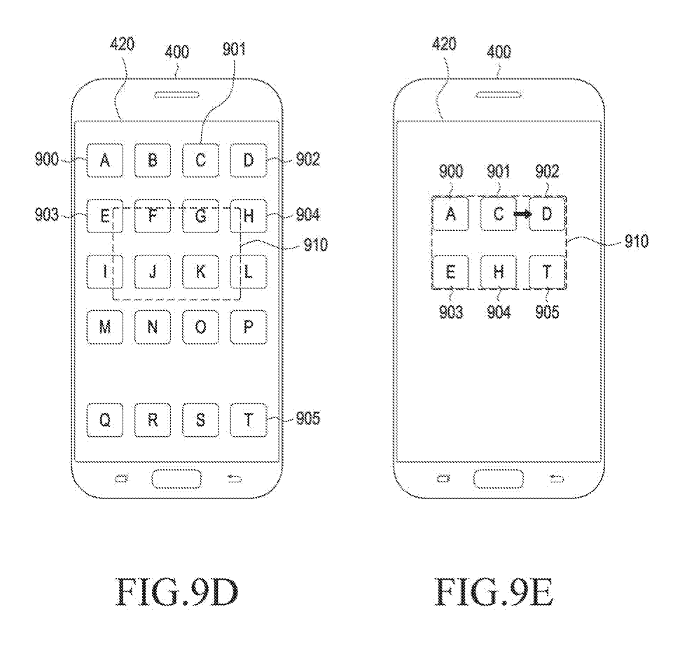

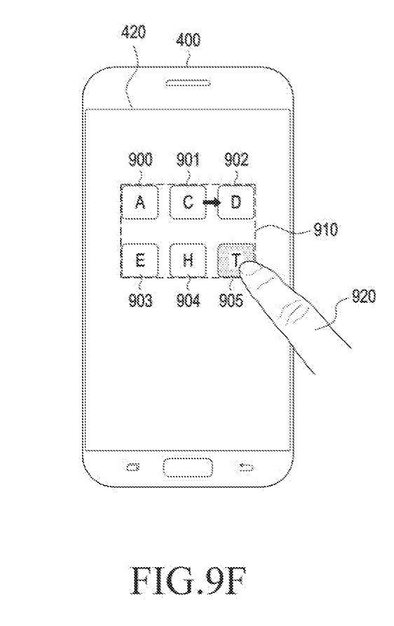

FIGS. 9A, 9B, 9C, 9D, 9E, and 9F show examples for describing a method of providing a user interface based on a location of an electronic device, according to various embodiments of the present disclosure.

Referring to FIGS. 9A, 9B, and 9C, the processor 410 may provide the first user interface corresponding to the contents related to an active area 910 of the first sensor 422 in the normal mode. The first user interface may include execution icons for respective applications A, B, C, . . . , S, T. Among the execution icons, an execution icon 900 of an application A, an execution icon 901 of an application C, an execution icon 902 of an application D, an execution icon 903 of an application E, an execution icon 904 of an application H, and an execution icon 905 of an application T may be execution icons of applications available in the under-water mode.

When determining through the first sensor 422 that at least a part of the electronic device 400 is located under water, the processor 410 may enter the under-water mode and may provide the second user interface including the execution icons 900, 901, 902, 903, 904, and 905 of the applications available in the under-water mode and selection icons 906, 907, and 908 for selecting the execution icons of the applications. For example, the processor 410 may arrange the selection icons 906, 907, and 908 corresponding to a second area 910 of the second sensor 423.

When the execution icon 901 of the application C is selected, upon detecting a plurality of fingerprints through the second area 910 of the second sensor 423, the processor 410 may generate an accumulation image where images of the detected fingerprints are accumulated chronologically. The processor 410 may identify an input form or direction of a finger by analyzing the generated accumulation image. For example, when analyzing that the accumulation image corresponds to a trajectory along which the accumulation image moves from a first direction 920 to a second direction 921, the processor 410 may identify detected fingerprint images as a swipe input (or a drag input) based on the input direction, and select the execution icon 902 of the application D in response to the swipe input (or a drag input).

Upon detecting a fingerprint in at least a part of the second area 910 corresponding to the first icon 906 related to an application execution function, the processor 410 may display an execution screen of the application D corresponding to the selected execution icon 902 of the application D on the touch screen 420.

Referring to FIGS. 9D, 9E, and 9F, the processor 410 may provide the first user interface corresponding to the first sensor 422 in the normal mode, and may enter (or switch to) the under-water mode when determining through the first sensor 422 that at least a part of the electronic device 400 is located under water. In the under-water mode, the processor 410 may provide the second user interface corresponding to the second area 910 of the second sensor 423. For example, the second user interface may include the execution icons 900, 901, 902, 903, 904, and 905 of the applications A, C, D, E, H, and T available in the under-water mode.

Upon detecting a fingerprint in at least a part of the second area 910 corresponding to the execution icon 905 of the application T, the processor 410 may identify the input form of the finger based on an image of the detected fingerprint. For example, when determining that the fingerprint image corresponds to a general fingerprint form (e.g., a previously stored user's fingerprint form), the processor 410 may identify the detected fingerprint as a touch input based on the identified input form. The processor 410 may display the execution screen of the application T corresponding to the execution icon 905 of the application T on the touch screen 420 based on the identified touch input.

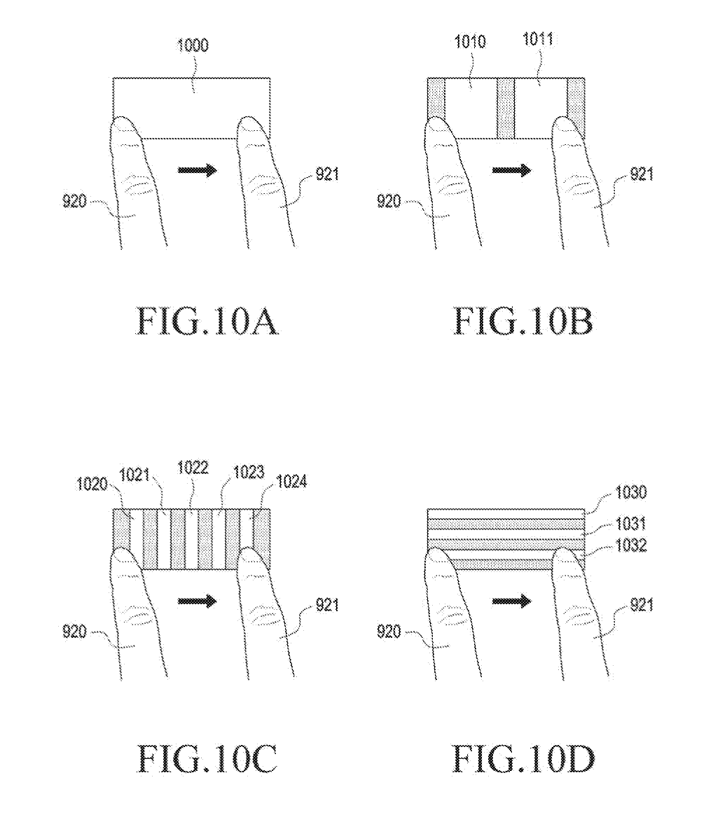

FIGS. 10A, 10B, 10C, and 10D show examples of a second area according to various embodiments of the present disclosure.

Referring to FIG. 10A, the second sensor 423 may activate a plurality of detection pixels corresponding to the entire area of a second area 1000 and detect the second input through the plurality of activated detection pixels of the second area 1000.

Referring to FIG. 10B, the second sensor 423 may activate a plurality of detection pixels corresponding to a first sub-area 1010 and a second sub-area 1011 of the second area, and deactivate detection pixels corresponding to the other sub-areas. For example, the second sensor 423 may obtain a first fingerprint image through activated detection pixels of the first area 1010 and obtain a second fingerprint image through activated detection pixels of the second area 1011. According to various embodiments of the present disclosure, the processor 410 may identify directions of a finger (e.g., from the first direction 920 to the second direction 921) based on the obtained first fingerprint image and second fingerprint image, and identify the obtained first fingerprint image and second fingerprint image as a swipe input, a pinch in/out input, etc., based on the identified input form or direction.

Referring to FIG. 10C, the second sensor 423 may divide the second area into longitudinally long rectangular sub-areas and sequentially deactivate or activate at least some of detection pixels corresponding to the divided sub-areas. The second sensor 423 may activate a first sub-area 1020, a second sub-area 1021, a third sub-area 1022, a fourth sub-area 1023, and a fifth sub-area 1024, and deactivate detection pixels corresponding to the other divided sub-areas. For example, the second sensor 423 may obtain a first fingerprint image through activated detection pixels of the first sub-area 1020, a second fingerprint image through activated detection pixels of the second sub-area 1021, a third fingerprint image through activated detection pixels of the third sub-area 1022, a fourth fingerprint image through activated detection pixels of the fourth sub-area 1023, and a fifth fingerprint image through activated detection pixels of the fifth sub-area 1024. According to various embodiments of the present disclosure, the processor 410 may identify directions of a finger (e.g., from the first direction 920 to the second direction 921) based on the obtained first, second, third, fourth, and fifth fingerprint images, and identify the detected first, second, third, fourth, and fifth fingerprint images as a swipe input, a pinch in/out input, etc., based on the identified input form or direction.

Referring to FIG. 10D, the second sensor 423 may divide the second area into horizontally long rectangular sub-areas and sequentially activate or deactivate at least some of detection pixels corresponding to the divided sub-areas. The second sensor 423 may activate a first sub-area 1030, a second sub-area 1031, and a third sub-area 1032, and deactivate detection pixels corresponding to the other divided sub-areas. For example, the second sensor 423 may obtain the first fingerprint image through activated detection pixels of the first sub-area 1030, obtain the second fingerprint image through activated detection pixels of the second sub-area 1031, and obtain the third fingerprint image through activated detection pixels of the third sub-area 1032. According to various embodiments of the present disclosure, the processor 410 may identify directions of a finger (e.g., from the first direction 920 to the second direction 921) based on the obtained first, second, and third fingerprint images, and identify the detected first, second, and third fingerprint images as a swipe input, a pinch in/out input, etc., based on the identified input form or direction.

As a resolution of the fingerprint image of the detected fingerprint may be reduced through some activated detection pixels, the processor 410 may operate fast using the fingerprint image with the reduced resolution.

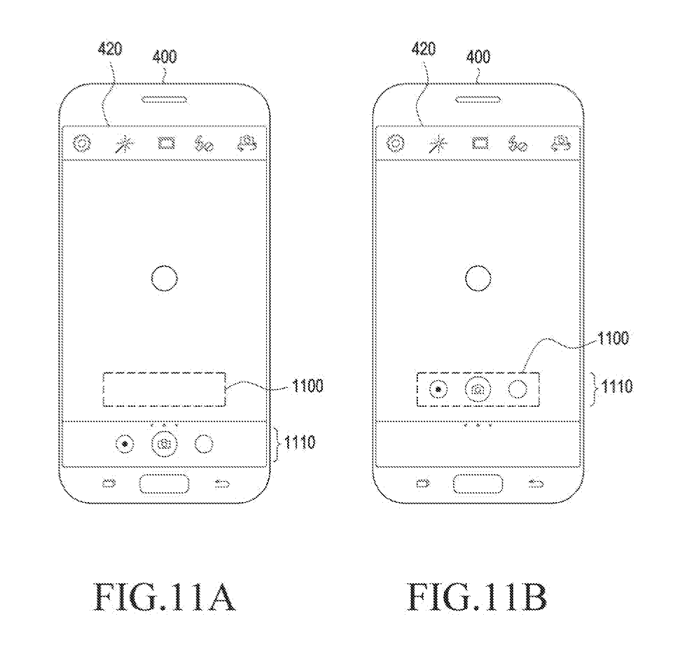

FIGS. 11A and 11B show examples of a first user interface and a second user interface according to various embodiments of the present disclosure.

Referring to FIGS. 11A and 11B, upon detecting the first input for selecting an execution icon corresponding to a camera application through the first sensor 422 in the normal mode, the processor 410 may display a camera application execution screen corresponding to the first area of the first sensor 422. The first area may correspond to the entire area of the touch screen 420. For example, in the normal mode, icons 1110 related to at least one function of the camera application may be located under the camera application execution screen.

The processor 410 may switch to the under-water mode when determining through the first sensor 422 that the electronic device 400 is located under water, and display the icons 1110 related to at least one function of the camera application to correspond to a second area 1100. For example, the processor 410 may move the icons related to at least one function of the camera application to a position corresponding to the second area 1100 in the under-water mode.

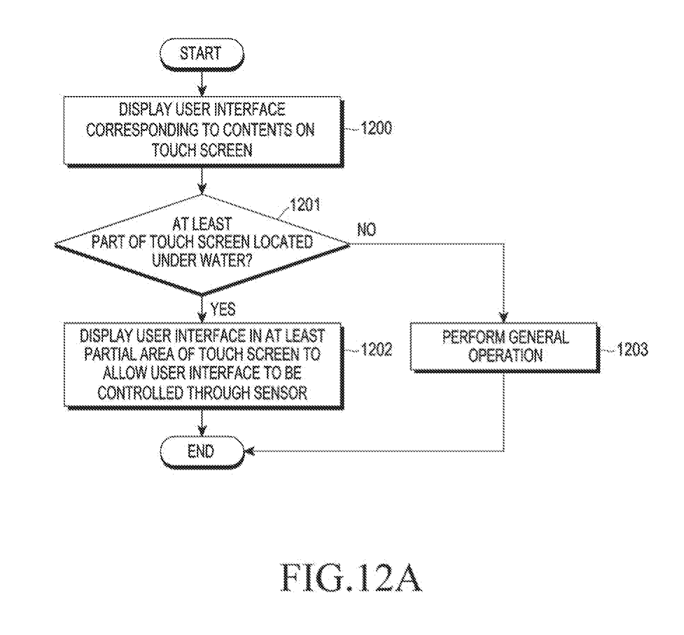

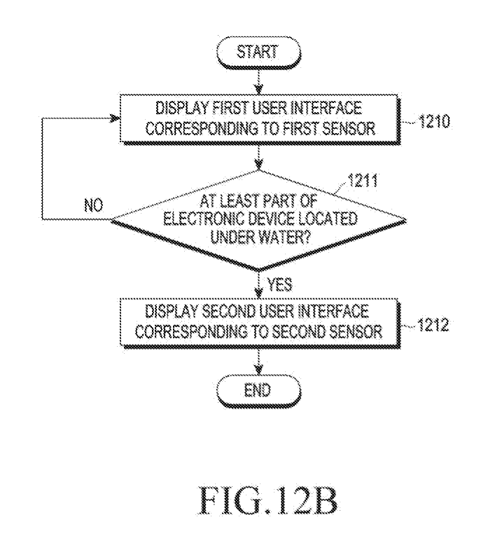

FIGS. 12A and 12B are flowcharts illustrating a method of providing a user interface based on a location of an electronic device, according to various embodiments of the present disclosure.

According to various embodiments of the present disclosure, operations 1200 through 1203 of FIG. 12A and operations 1010 through 1212 of FIG. 12B may be performed by any one of the electronic device 101, 102, 104, 201, or 400, the server 106, the processor 120, 210, or 410, and the programming module 310.

Referring to FIG. 12A, in operation 1200, the electronic device 400 (e.g., the processor 410) may display a user interface corresponding to contents on the touch screen 420.

The electronic device 400 (e.g., the processor 410) may determine whether at least a part of the touch screen 420 is located under water in operation 1201, and may perform operation 1202 when determining that the at least a part of the touch screen 420 is located under water and perform operation 1203 when determining that the at least a part of the touch screen 420 is not located under water. For example, when detecting a touch input in the entire area of the touch screen 420 or an area having a size larger than or equal to a threshold size, the electronic device 400 (e.g., the processor 410) may determine that the at least a part of the touch screen 420 is located under water.

In operation 1202, the electronic device 400 (e.g., the processor 410) may display a user interface in at least a partial area of the touch screen 420 to allow the user interface to be controlled through the sensor 440. For example, the electronic device 400 (e.g., the processor 410) may display an execution icon related to at least one application available under water.

In operation 1203, the electronic device 400 (e.g., the processor 410) may perform a general operation. For example, the general operation may include a case where the electronic device 400 operates in the normal mode.

Referring to FIG. 12B, in operation 1210, the electronic device 400 (e.g., the processor 410) may display the first user interface corresponding to the first sensor 422. For example, the first user interface may include a graphic object corresponding to contents on the touch screen 420 (e.g., at least one application or application execution screen, etc.).

The electronic device 400 (e.g., the processor 410) may determine whether at least a part of the electronic device 400 is located under water in operation 1211, and may perform operation 1212 when determining that the at least a part of the electronic device 400 is located under water and display the first user interface corresponding to the first sensor 422 in operation 1210 when determining that the at least a part of the touch screen 400 is not located under water.

In operation 1212, the electronic device 400 (e.g., the processor 410) may display the second user interface corresponding to the second sensor 423. For example, the second user interface may include a graphic object corresponding to a part of contents on the touch screen 420.

According to various embodiments of the present disclosure, the electronic device 400 including the touch screen 420, the sensor 440 formed in at least a partial area of the touch screen 420, and the processor 410 may, by using the processor 410, display a user interface corresponding to contents on the touch screen 420 to allow the user interface to be controlled through the touch screen 420, and may display the user interface on at least a partial area of the touch screen 420 to allow the user interface to be controlled through the sensor 440 when determining through the touch screen 420 that at least a part of the touch screen 420 is located under water.

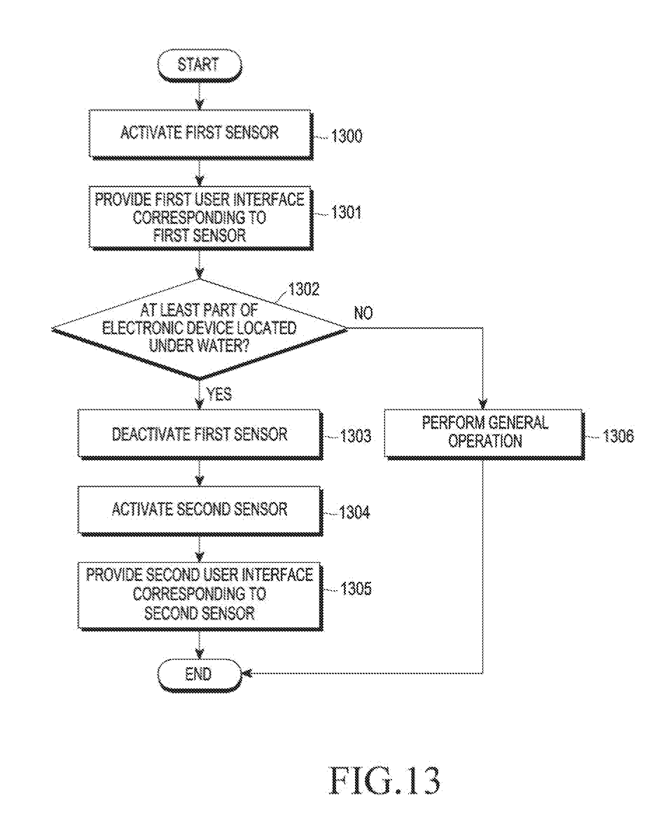

FIG. 13 is a flowchart illustrating a method of providing a user interface based on a location of an electronic device according to various embodiments of the present disclosure.

According to various embodiments, operations 1300 through 1306 may be performed by any one of the electronic device 101, 102, 104, 201, or 400, the server 106, the processor 120, 210, or 410, and the programming module 310.

Referring to FIG. 13, in operation 1300, the electronic device 400 (e.g., the processor 410) may activate the first sensor 422. For example, the electronic device 400 (e.g., the processor 410) may sense the first input by using the first sensor 422 in the normal mode. The electronic device 400 (e.g., the processor 410) may activate the second sensor 423 in response to a request for fingerprint authentication, perform fingerprint authentication by using the activated second sensor 423, and deactivate the second sensor 423 upon completion of fingerprint authentication. This operation is selectively performed, and the second sensor 423 may maintain an active state.

In operation 1301, the electronic device 400 (e.g., the processor 410) may provide the first user interface corresponding to the first sensor 422.

The electronic device 400 (e.g., the processor 410) may determine whether at least a part of the electronic device 400 is located under water in operation 1302, and may perform operation 1303 when determining that the at least a part of the electronic device 400 is located under water and perform the general operation in operation 1306 when determining that the at least a part of the electronic device 400 is not located under water.

In operation 1303, the electronic device 400 (e.g., the processor 410) may deactivate the first sensor 422. According to various embodiments of the present disclosure, operation 1303 may be performed selectively.

In operation 1304, the electronic device 400 (e.g., the processor 410) may activate the second sensor 423. For example, the electronic device 400 (e.g., the processor 410) may enter (or switch to) the under-water mode.

In operation 1305, the electronic device 400 (e.g., the processor 410) may provide the second user interface corresponding to the second sensor 423. For example, the second user interface may include an execution/shortcut icon corresponding to at least one application available in the under-water mode among a plurality of applications or an icon, controller, scroll, menu, etc., included in an application execution screen.

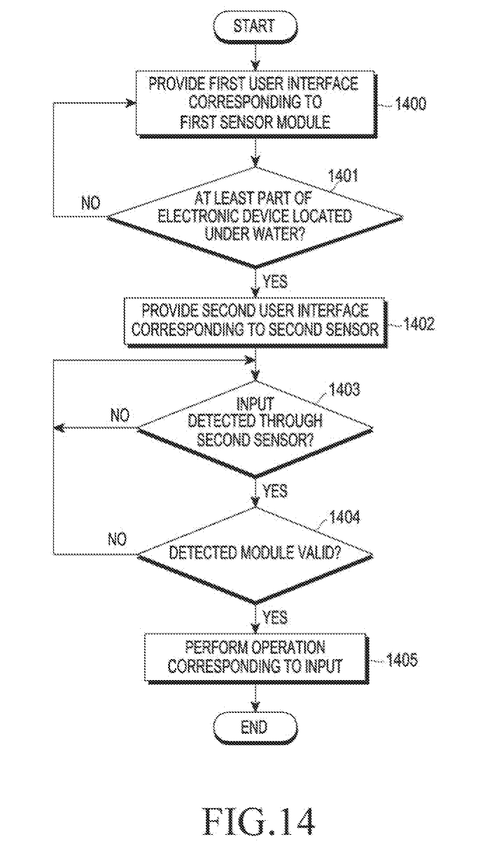

FIG. 14 is a flowchart illustrating a method of providing a user interface based on a location of an electronic device according to various embodiments of the present disclosure.

According to various embodiments, operations 1400 through 1405 may be performed by any one of the electronic device 101, 102, 104, 201, or 400, the server 106, the processor 120, 210, or 410, and the programming module 310.

Referring to FIG. 14, in operation 1400, the electronic device 400 (e.g., the processor 410) may provide the first user interface corresponding to the first sensor 422. For example, the electronic device 400 (e.g., the processor 410) may operate in the normal mode.

The electronic device 400 (e.g., the processor 410) may determine whether at least a part of the electronic device 400 is located under water in operation 1401, and may perform operation 1402 when determining that the at least a part of the electronic device 400 is located under water and provide the first user interface corresponding to the first sensor 422 in operation 1400 when determining that the at least a part of the touch screen 400 is not located under water.

In operation 1402, the electronic device 400 (e.g., the processor 410) may provide the second user interface corresponding to the second sensor 423.

The electronic device 400 (e.g., the processor 410) may determine whether an input is detected through the second sensor 423 in operation 1403, perform operation 1404 when determining that the input is detected through the second sensor 423, and determine whether the input is detected through the second sensor 423 in operation 1400 when determining that the input is not detected through the second sensor 423. For example, the input may include one fingerprint or a plurality of fingerprints.

The electronic device 400 (e.g., the processor 410) may determine whether the detected input is valid in operation 1404, perform operation 1405 when determining that the detected input is valid, and determine whether the input is detected through the second sensor 423 in operation 1400 when determining that the detected input is not valid. For example, the electronic device 400 (e.g., the processor 410) may determine that the detected input is not valid, when detecting the fingerprint for a time shorter than a designated first time. When detecting the fingerprint during the first time or longer, the electronic device 400 (e.g., the processor 410) may determine that the detected fingerprint is a valid input.

In operation 1405, the electronic device 400 (e.g., the processor 410) may activate a function of the electronic device 400 corresponding to the detected input.

According to various embodiments of the present disclosure, when an electronic device is located under water, the electronic device may be controlled using a user interface corresponding to a sensor other than a touch sensor.

A term “module” used herein may mean, for example, a unit including one of or a combination of two or more of hardware, software, and firmware, and may be used interchangeably with terms such as logic, a logic block, a part, or a circuit. The “module” may be a part configured integrally, a minimum unit or a portion thereof performing one or more functions. The “module” may be implemented mechanically or electronically, and may include an application-specific integrated circuit (ASIC) chip, field-programmable gate arrays (FPGAs), and a programmable-logic device performing certain operations already known or to be developed. At least a part of an apparatus (e.g., modules or functions thereof) or a method (e.g., operations) according to various embodiments may be implemented with an instruction stored in a computer-readable storage medium (e.g., the memory 130) in the form of a programming module. When the instructions are executed by a processor (for example, the processor 120), the processor may perform functions corresponding to the instructions. The computer-readable recording medium includes hard disk, floppy disk, or magnetic media (e.g., a magnetic tape, optical media (e.g., compact disc read only memory (CD-ROM) or digital versatile disc (DVD), magneto-optical media (e.g., floptical disk), an embedded memory, and so forth. The instructions may include a code generated by a compiler or a code executable by an interpreter. Modules or programming modules according to various embodiments of the present disclosure may include one or more of the foregoing elements, have some of the foregoing elements omitted, or further include additional other elements. Operations performed by the module, the program, or another component according to various embodiments may be carried out sequentially, in parallel, repeatedly, or heuristically, or one or more of the operations may be executed in a different order or omitted, or one or more other operations may be added.

What is claimed is:

1. An electronic device comprising:
a touch screen;
a sensor formed in at least a partial area of the touch screen; and
a processor,
wherein the processor is configured to:
display a user interface corresponding to contents on the touch screen to allow the user interface to be controlled through the touch screen; and
display the user interface in the at least a partial area of the touch screen to allow the user interface to be controlled through the sensor, when identifying through the touch screen that at least a part of the touch screen is located under water.

2. The electronic device of claim 1, wherein the processor is configured to identify whether at least a part of the electronic device is located under water, by using the touch screen.

3. The electronic device of claim 2, wherein the processor is configured to identify that the electronic device is located under water, when detecting a first input having a capacitance value that is greater than or equal to a threshold value in terms of an area having a size larger than or equal to a threshold size in an area corresponding to the touch screen.

4. The electronic device of claim 1, wherein a size of an area corresponding to the sensor is set smaller than a size of the area corresponding to the touch screen.

5. The electronic device of claim 1, wherein the area corresponding to the sensor is configured to correspond to at least a part of the area corresponding to the touch screen.

6. The electronic device of claim 1, wherein the user interface comprises a graphic object corresponding to at least a part of the contents.

7. The electronic device of claim 1, wherein the processor is configured to perform a function corresponding to a second input upon detecting the second input in the at least a partial area.

8. The electronic device of claim 1, wherein the touch screen comprises a capacitive touch sensor.

9. The electronic device of claim 1, wherein the sensor comprises a fingerprint sensor or an optical sensor.

10. The electronic device of claim 9, wherein the fingerprint sensor comprises at least one of an optical sensor or an ultrasonic sensor.

11. A non-transitory recording medium having stored therein instructions for executing a method for controlling an electronic device,
wherein the instructions are configured to cause, when executed by at least one processor, the at least one processor to perform at least one operation which comprises:
displaying a user interface corresponding to contents on the touch screen to allow the user interface to be controlled through the touch screen; and
displaying the user interface in at least a partial area of the touch screen to allow the user interface to be controlled through a sensor formed in the at least a partial area of the touch screen, when identifying through the touch screen that at least a part of the touch screen is located under water.

12. The non-transitory recording medium of claim 11, wherein the identifying of whether the electronic device is located under water comprises identifying whether at least a part of the electronic device is located under water, by using the touch screen.

13. The non-transitory recording medium of claim 12, wherein the at least one operation further comprises identifying that the at least a part of the electronic device is located under water, when detecting a first input having a capacitance value that is greater than or equal to a threshold value in terms of an area having a size larger than or equal to a threshold size in an area corresponding to the touch screen.

14. The non-transitory recording medium of claim 11, wherein a size of an area corresponding to the sensor is set smaller than a size of the area corresponding to the touch screen.

15. The non-transitory recording medium of claim 14, wherein the area corresponding to the sensor is configured to correspond to at least a part of the area corresponding to the touch screen.
